(19) United States
(12) Patent Application Publication
(10) Pub. No.: US 2007/0078234 A1
(43) Pub. Date: Apr. 5, 2007

(54) Composition for producing polyurea coatings

(75) Inventors: Michael Mager, Leverkusen (DE); Malte Homann, Odenthal (DE); Andreas Aus der Wieschen, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/523,988

(22) Filed: Sep. 20, 2006

(30) Foreign Application Priority Data
Oct. 4, 2005 (DE) 102005047560.4

(51) Int. Cl. C08F 283/04; C08G 18/77

(52) U.S. Cl. 525/424; 528/73

(57) ABSTRACT

The invention relates to innovative compositions containing polyisocyanates containing allophanate groups and polyamines, preferably aromatic diamines, and optionally further polyisocyanates, preferably polyisocyanates containing uretdione groups, and also their use for producing quick-curing polyurea coatings.

### BACKGROUND OF THE INVENTION

1. Field of the Invention

The present invention relates to compositions containing polyisocyanates having allophanate groups, polyamines, preferably aromatic diamines, and optionally other polyisocyanates, preferably polyisocyanates containing uretdione groups, and to their use for producing fast curing polyurea coatings.

2. Description of Related Art

Coatings containing polyureas are of interest particularly in view of the facts that the reaction of polyisocyanates with amines proceeds extraordinarily quickly and the coated surfaces are very quickly serviceable. Also, the presence of urea groups in polyurethanes results in a very favorable tradeoff between hardness and elasticity, and in many coating applications this is highly desirable.

Polyureas which can be used to coat pipes are described for example in EP-A 0 936 235. They are obtained by mixing a liquid aliphatic polyisocyanate, which in addition may also contain a liquid epoxy resin, with a liquid aromatic polyamine. The resulting coatings, though, are very brittle.

In order to make such polyurea coatings flexible it is possible to admix the aromatic diamines of EP-A 1 486 522 with polyhydroxy compounds such as polyether polyols or polyester polyols; prepolymers of hexamethylene diisocyanate (HDI) or its dimer or trimer; or amine-terminated polyethers. These options for flexibilizing polyurea coatings have the following disadvantages. When polyethers and polyesters are employed, there is a considerable increase in the cure time, since the NCO/OH reaction is markedly slower than the NCO/NH₂ reaction. Also, polyesters have a high viscosity, which considerably hampers their processing in these highly reactive mixtures. Even simple prepolymers of HDI or its oligomers have excessive viscosities and display incompatibilities in the fully reacted polyurea (inhomogeneous coatings). Since the reactivity of amine-terminated polyethers and aromatic diamines is very different, the result here is also inhomogeneous systems.

It is an object of the present invention to provide compositions which exhibit low viscosity and can be cured under ambient conditions in a short time to form homogeneous, flexibilized polyureas.

Surprisingly it has now been found that compositions containing particular (cyclo)aliphatic polyisocyanate prepolymers having allophanate groups in combination with polyamines and optionally other polyisocyanates can be cured under ambient conditions in a short time to form homogeneous, flexible polyureas.

### SUMMARY OF THE INVENTION

The present invention relates to compositions containing
A) a polyisocyanate prepolymer which has polyether groups attached via allophanate groups,
B) polyamines containing at least two primary amino groups, and
C) optionally other polyisocyanates.

### DETAILED DESCRIPTION OF THE INVENTION

The allophanate group-containing prepolymers used in component A) are obtained by reacting
A1) one or more aliphatic and/or cycloaliphatic polyisocyanates with
A2) a polyhydroxy component containing at least one polyether polyol, to provide an NCO-functional polyurethane prepolymer and then subsequently subjecting the urethane groups thus formed to partial or complete allophanatization with the addition of
A3) polyisocyanates, which may be different from A1),
A4) catalysts and
A5) optionally stabilizers.

Examples of suitable aliphatic and cycloaliphatic polyisocyanates A1) include diisocyanates or triisocyanates such as butane diisocyanate, pentane diisocyanate, hexane diisocyanate (hexamethylene diisocyanate, HDI), 4-isocyanatomethyl-1,8-octane diisocyanate (triisocyanatononane, TIN), 4,4′-methylenebis(cyclohexyl isocyanate), 3,5,5-trimethyl-1-isocyanato-3-isocyanatomethylcyclohexane (isophorone diisocyanate, IPDI) and also ω,ω′-diisocyanato-1,3-dimethylcyclohexane (H₆XDI).

In components A1) and A3) it is preferred to employ hexane diisocyanate (hexamethylene diisocyanate, HDI), 4,4′-methylenebis(cyclohexyl isocyanate) and/or 3,5,5-trimethyl-1-isocyanato-3-isocyanatomethylcyclohexane (isophorone diisocyanate, IPDI) as polyisocyanates. One very particularly preferred polyisocyanate is HDI. In components A1) and A3) it is preferred to employ polyisocyanates of the same type.

Suitable polyhydroxy compounds of component A2) include all of the known polyhydroxy compounds, which preferably have an average OH functionality of greater than or equal to 1.5, provided that at least one of the compounds included in component A2) is a polyether polyol.

Suitable polyhydroxy compounds which can be employed in component A2) are low molecular weight diols (e.g. 1,2-ethanediol, 1,3- and 1,2-propanediol, and 1,4-butanediol); triols (e.g. glycerol and trimethylolpropane); and tetraoles (e.g. pentaerythritol); polyether polyols; polyester polyols; polycarbonate polyols; and polythioether polyols. In component A2) it is preferred to exclusively use polyether polyols as the polyhydroxy component.

The polyether polyols employed in component A2) preferably have number average molecular weights Mₙ of 300 to 20,000 g/mol, more preferably 1000 to 12,000, and most preferably 2000 to 6000 g/mol. They preferably have an average OH functionality of ≧1.5, more preferably ≧1.90, and most preferably ≧1.95. These polyether polyols are obtained in known manner by the alkoxylation of suitable starter molecules under base catalysis or with the use of double metal cyanide compounds (DMC compounds).

Preferred polyether polyols of component A2) are those having an unsaturated end group content of less than or equal to 0.02 milliequivalents per gram of polyol (meq/g), more preferably less than or equal to 0.015 meq/g, and most preferably less than or equal to 0.01 meq/g (determination method: ASTM D2849-69).

Suitable starter molecules for the preparation of the polyether polyols include low molecular weight monomeric polyols, water, organic polyamines having at least two N—H bonds, or mixtures of these starter molecules. Alkylene oxides suitable for the alkoxylation are preferably ethylene oxide and/or propylene oxide, which can be employed in any order or in admixture in the alkoxylation.

Preferred starter molecules for preparing polyether polyols by alkoxylation, in particular by the DMC method, include monomeric polyols such as ethylene glycol, propylene 1,3-glycol, butane-1,4-diol, hexane-1,6-diol, neopentyl glycol, 2-ethylhexan-1,3-diol, glycerol, trimethylolpropane and pentaerythritol, and also low molecular weight, hydroxyl-containing esters of these polyols with the dicarboxylic acids described below, or low molecular weight ethoxylation or propoxylation products of these monomeric polyols, or desired mixtures of these modified or non-modified alcohols.

The polyurethane prepolymers containing isocyanate groups are prepared by reacting the polyhydroxy compounds of component A2) with excess amounts of polyisocyanates A1). The reaction takes place preferably at temperatures from 20 to 140° C., more preferably at 40 to 110° C., optionally with the use of the known catalysts from polyurethane chemistry, such as tin soaps, e.g. dibutyltin dilaurate, or tertiary amines, e.g. triethylamine or diazabicyclooctane.

The allophanatization then takes place subsequently by reaction of the resulting polyurethane prepolymers containing isocyanate groups with polyisocyanates A3), which may be the same as or different from those of component A1), with the addition of suitable catalysts A4) for the allophanatization. Preferably then acidic additives of component A5) are added for the purpose of stabilization, and excess polyisocyanates are removed from the product, for example, by thin-film distillation or extraction.

The equivalent ratio of the OH groups of the compounds of component A2) to the NCO groups of the polyisocyanates from A1) and A3) is preferably 1:1.5 to 1:20, more preferably 1:2 to 1:15, and most preferably 1:2 to 1:10.

For allophanatization zinc(II) compounds are preferably used as catalysts A4), more preferably, zinc soaps of relatively long-chain, branched or unbranched, aliphatic carboxylic acids. Preferred zinc(I) soaps are those based on 2-ethylhexanoic acid or on the linear aliphatic C₄ to C₃₀ carboxylic acids. Very particularly preferred compounds A4) are Zn(II) bis(2-ethylhexanoate), Zn(II) bis(n-octoate), Zn(II) bis(stearate) or mixtures thereof. The allophanatization catalysts are preferably employed in amounts of up to 5% by weight, more preferably 5 to 500 ppm, and most preferably 20 to 200 ppm, based on the reaction mixture as a whole.

Optionally, it is possible before, during or after the allophanatization to use additives A5) which have a stabilizing action. They may be acidic additives such as Lewis acids (electron deficient compounds) or Bronsted acids (protic acids) or compounds which liberate such acids by reaction with water. Examples include organic or inorganic acids or neutral compounds such as acid halides or esters which react with water to form the corresponding acids. Examples include hydrochloric acid, phosphoric acid, phosphoric esters, benzoyl chloride, isophthaloyl dichloride, p-toluenesulphonic acid, formic acid, acetic acid, dichloroacetic acid and 2-chloropropionic acid.

The acidic additives may also be used to deactivate the allophanatization catalyst. They also improve the stability of the allophanates prepared in accordance with the invention during thermal exposure in the course of thin-film distillation or during storage of the products, for example. The acidic additives are generally added in an amount such that the molar ratio of the acidic centers of the acidic additive and of the catalyst is at least 1:1. Preferably, however, an excess of the acidic additive is added. When acidic additives are used, they are preferably organic acids such as carboxylic acids or acid halides such as benzoyl chloride or isophthaloyl dichloride.

Excess monomeric diisocyanate can be separated off, if desired, after the allophanatization has been concluded. Thin-film distillation is the preferred method for separation, and is preferably carried out at temperatures of 100 to 160° C. under a pressure of 0.01 to 3 mbar. The resulting residual monomer content (diisocyanate) is preferably less than 1% by weight, more preferably less than 0.5% by weight.

The overall process steps for preparing the polyisocyanate prepolymer containing allophanate groups can be carried out optionally in the presence of inert solvents. Inert solvents are those which do not react with the reactants under the prevailing reaction conditions. Examples include ethyl acetate, butyl acetate, methoxypropyl acetate, methyl ethyl ketone, methyl isobutyl ketone, toluene, xylene, aromatic or (cyclo)aliphatic hydrocarbon mixtures or mixtures of these solvents. Preferably, however, the reactions according to the invention are carried out solvent-free.

The components involved can be added in any order both during the preparation of the prepolymers containing isocyanate groups and during allophanatization. It is preferred, however, to add polyether polyol component A2) to the initial polyisocyanate charge of components A1) and A3), and to then add the allophanatization catalyst A4).

In one preferred embodiment of the invention the polyisocyanates of components A1) and A3) are introduced as an initial charge in an appropriate reaction vessel and this initial charge is heated, with optional stirring, to 40 to 110° C. After the desired temperature has been reached, the polyhydroxy compounds of component A2) are then added with stirring and stirring is continued until the NCO content equals or is slightly below the theoretical NCO content of the polyurethane prepolymer based on the chosen stoichiometry. At this point the allophanatization catalyst A4) is added and the reaction mixture is heated at 50 to 100° C. until the NCO content equals or is slightly below the desired NCO content. Following addition of acidic additives as stabilizers A5), the reaction mixture is cooled or passed on directly for thin-film distillation. In that procedure the excess polyisocyanate is separated off at temperatures from 100 to 160° C. under a pressure of 0.01 to 3 mbar down to a residual monomer content of less than 1%, preferably less than 0.5%. After the thin-film distillation it is possible to add any further stabilizers.

The resulting allophanates A) preferably have number average molecular weights of 700 to 50,000 g/mol, more preferably 1500 to 8000 g/mol and most preferably 1500 to 4000 g/mol and have viscosities at 23° C. of 500 to 100,000 mPa·s, preferably 500 to 50,000 mPa·s, more preferably 1000 to 7500 mPa·s, and most preferably 1000 to 3500 mPa·s.

The allophanates preferably correspond to the formula I)

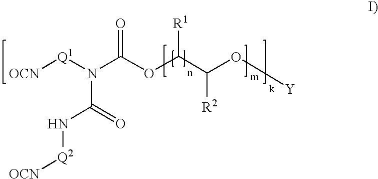

wherein
Q¹ and Q² independently of one another represent the radical obtained by removing the isocyanate groups from a linear and/or cycloaliphatic diisocyanate, preferably those previously disclosed, and more preferably —(CH₂)₆—,
R¹ and R² independently of one another represent hydrogen or a C₁-C₄ alkyl radical, preferably hydrogen and/or a methyl group, wherein R¹ and R² may be different in each repeating unit m,
Y represents the radical obtained by removing the reactive hydrogen groups, preferably hydroxyl groups, from a polyether starter molecule having a functionality of 2 to 6,
k is 2 to 6, and may be a fractional number when starter molecules having different functionalities are used,
m has a value such that the number average molecular weight of the polyether on which the structure is based is 300 to 20,000 g/mol, and
n is 1 or 3.

Especially preferred allophanates are those corresponding to formula II)

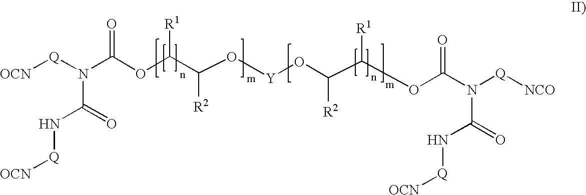

wherein
Q represents the radical obtained by removing the isocyanate groups from a linear and/or cycloaliphatic diisocyanate, preferably those previously disclosed, and more preferably —(CH₂)₆—,

R¹ and R² independently of one another represent hydrogen or a C₁-C₄ alkyl radical, preferably hydrogen and/or a methyl group, wherein R¹ and R² may be different in each repeating unit m,
Y represents the radical obtained by removing the reactive hydrogen groups, preferably hydroxyl groups, from a difunctional polyether starter molecule, and
m has a value such that the number average molecular weight of the polyether on which the structure is based is 300 to 20,000 g/mol, and
n is 1 or 3.

When the allophanates of formulas I) and II) are prepared using polyols based on polymerized ethylene oxide, propylene oxide or tetrahydrofuran, in formulas I) and II), when n=1, preferably at least one of the radicals R¹ and R² is hydrogen, and when n=3, R¹ and R² are hydrogen.

Suitable polyamines B) include aromatic, aliphatic, cycloaliphatic or heterocyclic compounds, preferably aromatic compounds, having at least two primary or secondary amino groups per molecule, preferably at least two primary amino groups per molecule.

Particularly suitable polyamines are aromatic diamines, such as optionally substituted tolylenediamines or methylenebis(anilines). Specific examples include diethyl-tolylenediamines, dimethylthiotolylenediamines, particularly isomers of each of these diamines containing amino groups in the 2,4 and 2,6 position, and also mixtures thereof; and also 4,4′-methylenebis(2-isopropyl-6-methylaniline), 4,4′-methylenebis(2,6-diisopropylaniline), 4,4′-methylenebis(2-ethyl-6-methylaniline) and 4,4′-methylenebis(3-chloro-2,6-diethylaniline).

In addition to polyisocyanates A1), also suitable as polyisocyanates C) are the known derivatives of aliphatic or cycloaliphatic polyisocyanates having uretdione, biuret and/or isocyanurate groups which can be obtained by modifying monomeric diisocyanates such as butane diisocyanate, pentane diisocyanate, hexane diisocyanate (hexamethylene diisocyanate, HDI), 4-isocyanatomethyl-1,8-octane diisocyanate (triisocyanatononane, TIN), 4,4′-methylenebis(cyclohexylisocyanate), 3,5,5-trimethyl-1-isocyanato-3-isocyanatomethylcyclohexane (isophorone diisocyanate, IPDI) and ω,ω′-diisocyanato-1,3-dimethylcyclohexane (H₆XDI).

Preferably the compositions of the invention contain polyisocyanates C) having uretdione groups, preferably prepared from hexamethylene diisocyanate (HDD.

It will be appreciated that the known additives can be added to the compositions of the invention, such as pigments, thixotropic agents, flow control agents, emulsifiers and stabilizers. The addition of catalysts for curing is possible, but typically not necessary.

The compositions of the invention are prepared by mixing components A), B) and optionally C) in any order before or during their application, as a coating for example. If component C) is employed, then it is preferably mixed first with component A) and then the resulting mixture is cured with component B).

The compositions of the invention can be applied to surfaces using the known techniques such as spraying, dipping, flooding or pouring. Following flashing off to remove any solvents present, the compositions are preferably free from solvents, the coatings are then cured under ambient conditions, in particular at −20° C. to +40° C., or at elevated temperatures of +40 to +200° C., for example.

The compositions can be applied for example to metals such as iron, steel, aluminium, bronze, brass or copper; plastics; ceramic materials such as glass; concrete; stone; and natural substances. The substrates may have been subjected to any required pretreatment beforehand. The compositions are applied preferably to iron or steel. Due to their rapid curing, the compositions are particularly suitable for the (interior) coating of pipes, especially pipes for conveying mineral oil, drinking water, gas or chemicals.

The invention is further illustrated but is not intended to be limited by the following examples in which all parts and percentages are by weight unless otherwise specified.

### EXAMPLES

The NCO contents were determined by back-titrating dibutylamine added in excess with hydrochloric acid.

The viscosity measurement took place using a rotational viscometer from Haake at 23° C.

The extension and the tensile strength were determined in a tensile test in accordance with EN ISO 527. The Shore hardness was determined using a manual instrument from Erichsen.

Desmodur N 3400 (Bayer MaterialScience AG, Leverkusen, D E) is a polyisocyanate which is prepared from hexamethylene diisocyanate, contains uretdione groups and has an NCO content of 21.8%.

Ethacure 300 (Albemarle Corporation) is an isomer mixture composed of 3,5-dimethylthiotolylene-2,4-diamine and 3,5-dimethylthiotolylene-2,6-diamine and has an amine equivalent weight of 107 g.

BYK A 530 is an additive available from Byk Chemie, Wesel, D E.

### Inventive Example 1

a) Preparation of a Polyisocyanate Containing Allophanate Groups:

2520.7 g of hexane 1,6-diisocyanate were first admised with 90 mg of isophthaloyl dichloride, after which the mixture was heated to 100° C. with stirring. At that point, over the course of 3 hours, 1978.5 g of a polypropylene glycol were added which had been prepared by DMC catalysis (base-free) (unsaturated groups content <0.01 meq/g, number average molecular weight 2000 g/mol, OH number 56 mg KOH/g, theoretical functionality 2). The reaction mixture was subsequently heated at 100° C. until an NCO content of 26.1% had been reached. Then the temperature was lowered to 90° C. and the reaction mixture, following the addition of 360 mg of zinc(II) bis(2-ethylhexanoate), was stirred until the NCO content was 24.3%. After 360 mg of isophthaloyl dichloride had been added, the excess hexane 1,6-diisocyanate was removed by means of thin-film distillation at <1 mbar and 140° C. This gave a product having an NCO content of 5.81% and a viscosity of 2200 mPa·s at 23° C.

b) Preparation of a Composition from the Polyisocyanate Containing Allophanate Groups from a) and an Aromatic Diamine

100 parts by weight of the polyisocyanate prepared in a) were mixed with 13.5 parts by weight of Ethacure 300 and the mixture was poured to give a film 2 mm thick. After curing (20 h at 40° C., then 3 d at room temperature) a transparent, homogeneous plastic was obtained. This product had the following mechanical properties:
Extension: 46%
Tensile strength: 48 MPa
Shore D hardness: 25

### Inventive Example 2

Starting from the allophanate prepared in example 1a), compositions containing a further polyisocyanate and an aromatic diamine were formulated, cured and subsequently tested.

The components and properties of the compositions are summarised in Table 1. The components were added with stirring in the amounts as set forth in Table 1, and within the potlife of approximately 25 minutes, were poured out to give a film 2 mm thick. After curing (7 days at room temperature), transparent, homogeneous plastics were obtained. The mechanical properties of these transparent, homogenous plastics were subsequently measured and are also summarised in Table 1.

TABLE 1

| | Composition 1 | Composition 2 |
|---|---|---|
| | Amount [g] | Amount [g] |
| Allophanate from Ex. 1a) | 290.5 | 219.0 |
| Desmodur ® N 3400 | 124.5 | 146.0 |
| Ethacure ® 300 | 107.0 | 107.0 |
| Byk A 530 | 5.22 | 4.72 |
| Extension [%] | 95 | 90 |
| Tensile strength [MPa] | 19.5 | 22 |
| Shore D hardness | 52 | 64Ab |

### Comparative Example 1

a) Preparation of a Polisocyanate Without Allophanate Groups:

734.7 g of hexane 1,6-diisocyanate were heated with stirring at 100° C. and admixed over 5 h with 865.0 g of a polypropylene glycol which had been prepared by DMC catalysis (base-free) (unsaturated groups content <0.01 meq/g, number average molecular weight 2000 g/mol, OH number 56 mg KOH/g, theoretical functionality 2). The reaction mixture was subsequently heated at 100° C. until an NCO content of 20.4% was reached. Following the addition of 320 mg of dibutyl phosphate the excess hexane 1,6-diisocyanate was removed by thin-film distillation at <1 bar and 140° C. The resulting product had the following properties: an NCO content of 3.21% and a viscosity (23° C.) of 1360 mPa·s.

b) Preparation of a Composition from the Polyisocyanate Without Allophanate Groups from a) and an Aromatic Diamine:

54.3 parts by weight of the polyisocyanate prepared in a) were mixed with 4.3 parts by weight of Ethacure 300 and the mixture was poured to give a film 2 mm thick. After curing (20 h at 40° C., then 3 d at room temperature), a transparent, homogeneous plastic was obtained. It was not possible to determine the Shore D hardness, since the test specimen was much too soft.

c) Preparation of a Composition from the Polyisocyanate Without Allophanate Groups from a), a Further Polyisocyanate and an Aromatic Diamine:

30 parts by weight of the polyisocyanate prepared in a) were mixed with 20 parts by weight of Desmodur N 3400 and 12.9 parts by weight of Ethacure 300, and the mixture was poured to give a film 2 mm thick. After curing (20 h at 40° C., 3 d at room temperature), a completely non-transparent, inhomogeneous plastic was obtained.

Aside from the inhomogeneity of the plastic, a Shore D hardness of only 38 was obtained, which was significantly less than the hardness for composition 2 of inventive example 2. In both cases the weight ratio of the particular polyisocyanate from a) to Desmodur N 3400 was 6:4.

### Comparative Example 2

30 g of an allophanate prepared from a low molecular weight monoalcohol and HDI, having an NCO content of 19.7% and a viscosity of 415 mPa·s, were mixed with 14.3 g of Ethacure 300 (stirring for 1 minute) and the mixture was then poured out to form a plate 3 mm thick. After 2 h at room temperature and 20 h at 40° C., a plastic was obtained which, due to its high brittleness, could not be analyzed for extension or tensile strength.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Compositions containing
A) a polyisocyanate prepolymer which has polyether groups attached via allophanate groups, and
B) polyamines containing at least two primary amino groups, and also
C) optionally further polyisocyanates.

2. The compositions according to claim 1, wherein A) said polyisocyanate prepolymer which contains allophanate groups are obtained by reacting
A1) one or more aliphatic and/or cycloaliphatic polyisocyanates with
A2) a polyhydroxy component containing at least one being a polyether polyol,
to yield an NCO-functional polyurethane prepolymer and then subsequently subjecting the urethane groups thus formed to partial or complete allophanatization with the addition of
A3) polyisocyanates, which may be different from those from Al), and
A4) catalysts, and
A5) optionally stabilizers.

3. The compositions according to claim 2, wherein A) said polyisocyanate prepolymer which contains allophanate groups is obtained from A1) a polyisocyanate comprising hexane diisocyanate (hexamethylene diisocyanate, HDI), 4,4′-methylenebis(cyclohexyl isocyanate), and/or 3,5,5-trimethyl-1-isocyanato-3-isocyanatomethylcyclohexane (isophorone diisocyanate, IPDI); and A3) a polyisocyanate comprising hexane diisocyanate (hexamethylene diisocyanate, HDI), 4,4′-methylenebis(cyclohexyl isocyanate), and/or 3,5,5-trimethyl-1-isocyanato-3-isocyanatomethylcyclohexane (isophorone diisocyanate, IPDI).

4. The compositions according to claim 2, in which A1) and A3) comprises polyisocyanates of the same type.

5. The compositions according to claim 2, wherein A4) said catalyst comprises one or more zinc(II) compounds.

6. The compositions according to claim 5, wherein said zinc(II) compounds comprise zinc(I) bis(2-ethylhexanoate), Zn(II) bis(n-octoate), Zn(H) bis(stearate) or mixtures thereof.

7. The compositions according to claim 2, wherein A2) said polyhydroxy component contains exclusively polyether polyols which have number-average molecular weights Mₙ of 2000 to 6000 g/mol, an average OH functionality of ≧1.95 and a degree of unsaturated end groups of less than or equal to 0.01 meq/g.

8. The compositions according to claim 2, in which the equivalent ratio of the OH groups of the compounds of component A2) to the NCO groups of the polyisocyanates from A1) and A3) is from 1:2 to 1:10.

9. The compositions according to claim 2, wherein A5) said stabilizers comprise organic or inorganic acids, acid halides or esters.

10. The compositions according to claim 1, wherein B) said polyamines comprise an aromatic diamine containing primary amino groups.

11. A coating obtained from the coating composition of claim 1.

12. A substrate that has been coated with the coating composition of claim 1.
